(19) United States
(12) Patent Application Publication
(10) Pub. No.: US 2023/0378779 A1
(43) Pub. Date: Nov. 23, 2023

(54) MOUNTING BRACKET FOR QUICK CONNECT MAGNETIC CHARGING CABLE

(71) Applicant: JAMSTACK INC., Toronto (CA)

(72) Inventor: Chris James PRENDERGAST, Toronto (CA)

(21) Appl. No.: 17/751,554

(22) Filed: May 23, 2022

(51) Int. Cl. H02J 7/00; H01R 13/62; H01R 31/06

(52) U.S. Cl. CPC H02J 7/0044; H01R 13/6205; H01R 31/06

(57) ABSTRACT

A mounting bracket for quick connect magnetic charging cable. This bracket facilitates the holding and self-positioning of a self-biasing cable (i.e., magnetic cable), such that it can quickly and easily connect the charging port of an electronics device, when the device is placed in proximately to the cable, thus removing the need for the user to insert the charging cable themselves with a separate action. The cable holding mechanism is mounted onto another mount designed to mechanically hold the electronic device in a specific orientation. One single action can be taken by the user (mounting the device) and thus enabling the wired charging

### CROSS REFERENCE TO RELATED APPLICATIONS

The application claims priority to and the benefit of U.S. Provisional Patent Application Ser. No. 63/191,988, entitled “MOUNTING BRACKET FOR QUICK CONNECT MAGNETIC CHARGING CABLE” filed on May 22, 2021, the disclosure of which is incorporated herein by reference in its entirety.

### BACKGROUND

The embodiments described herein relate to mounting bracket for a charging cable, specifically a self-biasing mounting bracket.

Charging devices often requires a conscious effort and thus the user can find that their device is not charged at inopportune times and must take up space in their minds about remembering to charge their many devices. By integrating charging into a “home base” the charging becomes automatic and thus removes the need to think about charging.

Charging a device with a cable involves fumbling for a cable, which may not be held in a certain place, and then searching for the port and placing it in. It also usually inhibits one handed removal of the device, which is especially important for portable devices.

Wireless charging can address some of these issues but only if it's already built into the product. Wireless charging also has more energy loss than cabled charging and also charges devices at slower rates. Wireless charging can even be impractical for larger current drawing devices, or devices that require high current output while in operation and simultaneous charging.

Devices exist with built in charging into their mechanisms themselves, but a solution is needed to allow devices to be both mechanically connected to a supportive mount while also routing power to the device without additional user interaction, particularly where routing power through the supportive mount connection is impractical

### SUMMARY

A mounting bracket for quick connect magnetic charging cable. This bracket facilitates the holding and self-positioning of a self-biasing cable (i.e., magnetic cable), such that it can quickly and easily connect the charging port of an electronics device, when the device is placed in proximately to the cable, thus removing the need for the user to insert the charging cable themselves with a separate action. The cable holding mechanism is mounted onto another mount designed to mechanically hold the electronic device in a specific orientation. One single action can be taken by the user (mounting the device) and thus enabling the wired charging.

### BRIEF DESCRIPTION OF THE DRAWINGS

FIG. 1 is a perspective view of a mounting bracket.

FIG. 2 is a right side view of a mounting bracket.

FIG. 3 is a perspective view of the vertical cable mount assembly.

FIG. 4 is front perspective view of the vertical cable mount assembly.

FIG. 5 is a front plan view of the vertical cable mount assembly

FIG. 6 is a perspective view of a mounting bracket attached to a speaker.

FIG. 7 is a bottom perspective view of a mounting bracket attached to a speaker.

FIG. 8 is a right side view of a mounting bracket attached to a speaker.

FIG. 9 is a bottom perspective view of the speaker mount assembly.

FIG. 10 is a section view of the joint connecting the speaker mount assembly, vertical cable mount assembly and wall bracket.

FIG. 11 is an exploded view of vertical cable mounting assembly and speaker mount assembly of a mounting bracket.

### DETAILED DESCRIPTION

This disclosure discloses a cable mounting bracket for an electronic device for secure mounting and rapid charging.

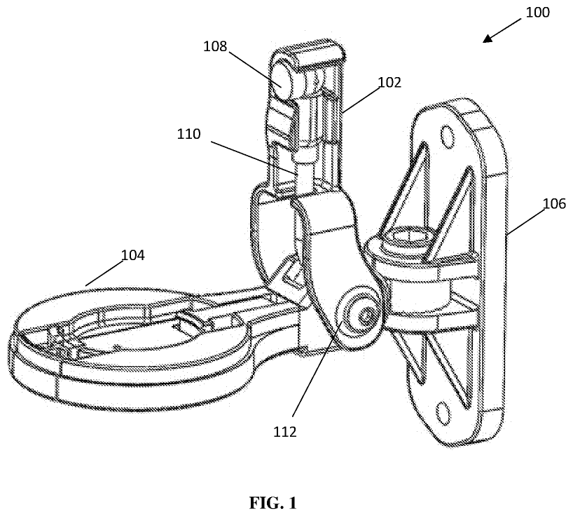

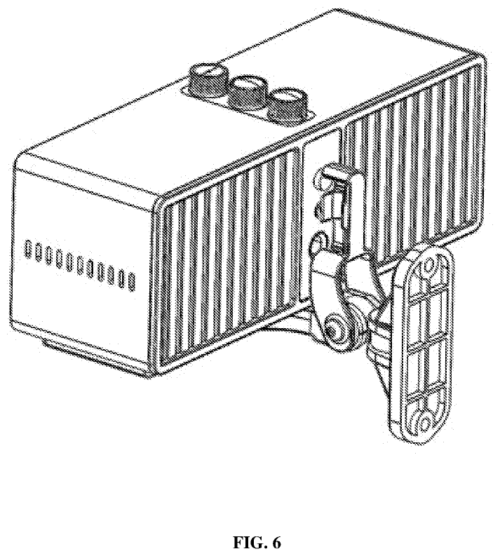

FIG. 1 is a perspective view of a mounting bracket. According to FIG. 1, mounting bracket 100 comprises vertical cable mount 102, speaker mount 104 and wall bracket 106. Vertical cable mount 102 also includes magnet 108 and receptacle for the cable to run therethrough. The cable magnet 108 further consists of a magnet and two or more electrical conductors (not shown) that allow for the charging and/or operation of the connected device. A mating connector on the device shown is connected to the mounting bracket in FIG. 6. The cable is not shown in FIG. 6 to show the device side of the electrical connector.

Alternate embodiments could have one side of the electrical connection (for example ground) through the mechanical portion of the bracket assembly (speaker mount 104) and a power and/or data connection through the cable. This would allow simplification of the cable to be one conductor. The conductor may be a metallic contact, including one of several widely known spring mounted electrical contacts. The contact mate may include a simple metal pad, or a more complex mechanical design, to maximize the contact area of the connection. The materials used in such spring mounted contacts are typically gold plated to provide resistance to corrosion, but many other metal types may be practical depending on the environment where the system is used.

Magnetically coupled electrical connectors are well known in the industry and are used on such devices as the Apple MacBook® laptops. A further advantage of having providing the cable separable from the mounting bracket is that the cable may be used with other brackets of different mounting design, or can be used with no bracket at all. The magnetic connector can be fashioned with a magnet of opposite polarities facing the mating face, or alternatively a magnet on one or the other of the mating faces, and a ferrous element on the other mating side.

According to FIG. 1, mounting bracket 100 also includes a pivotable hinge assembly 108 connecting the speaker mount 104, wall bracket mount 106 and vertical cable mount 102. Pivotable hinge assembly 112 is configured to pivot in two directions (e.g., vertical and horizontal or x and y directions). Connectivity of pivotable hinge assembly 112 can be a nut and bolt, screw, welded mechanism or any other coupling mechanisms known to a person skill in the art.

In addition to the wall mounting bracket shown in FIG. 1, other types of brackets suitable for mounting-to-mounting poles, bicycle frames, handlebars, poles, mounting stands are anticipated as alternate embodiments. The bracket can be formed from at least one of several materials including an injection molded plastic, metal, cast metal, or similar materials. In a preferred embodiment the device is a speaker system or a self-powered speaker system that includes a battery. One of the preferred embodiments would be mounting to a wall. Other embodiments may include mounting to speaker stands, tubes, features of a vehicle or other mobile device, or a platform to rest atop another surface.

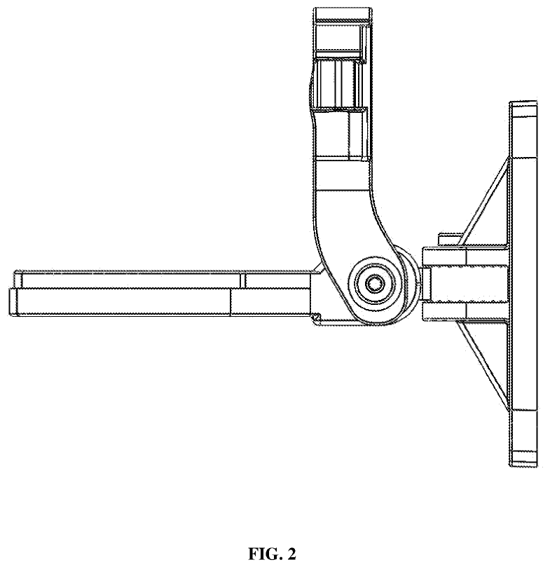

FIG. 2 is a right side view of a mounting bracket. An end view of the hinge mechanism is shown that allows for the rotation of the vertical cable mount 102 relative to the mechanical mouting arm 104. The vertical cable mount is connected such that relatively free angular rotation is permitted, and the magnetic attractive force that draws the magnet 108 to the mating magnet on the device causes the electrical contacts to mechanically and electrically connect. The magnet provides additional surety that the electrical connection will remain intact, particularly in the vibrating environment of connection to a speaker enclosure.

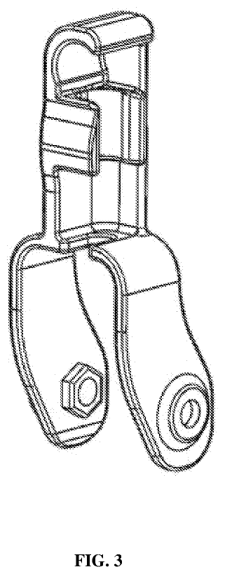

FIG. 3 is a perspective view of the vertical cable mount assembly, previously identified as vertical cable mount 102.

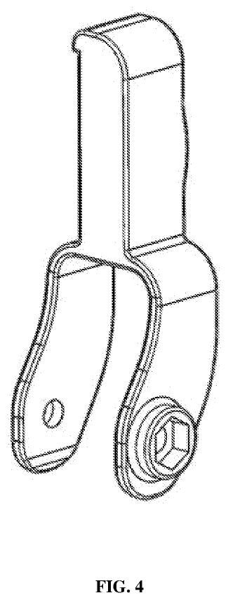

FIG. 4 is front perspective view of the vertical cable mount assembly.

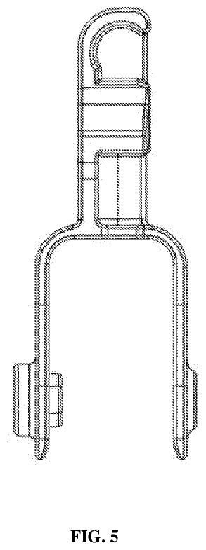

FIG. 5 is a front plan view of the vertical cable mount assembly

FIG. 6 is a perspective view of a mounting bracket attached to a speaker, previously identified as a device. A speaker is one of several types of devices that can be connected by this mechanical-electrical connection method. A speaker or powered speaker connection is a preferred embodiment because speakers often have high to moderate power requirements as well as high mobility requirements.

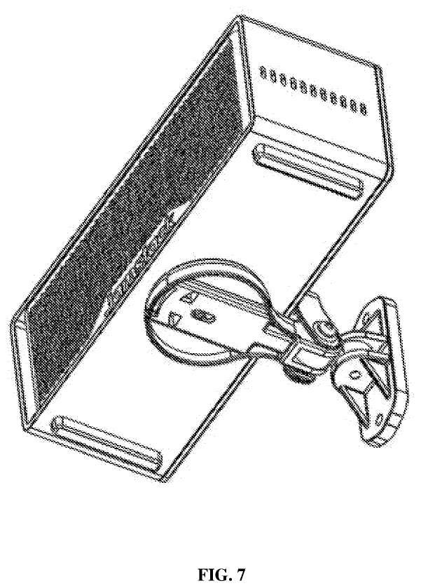

FIG. 7 is a bottom perspective view of a mounting bracket attached to a speaker. In this embodiment, the speaker slides onto the mechanical mounting mechanism towards the wall mount and is held in place by a captivation mechanism.

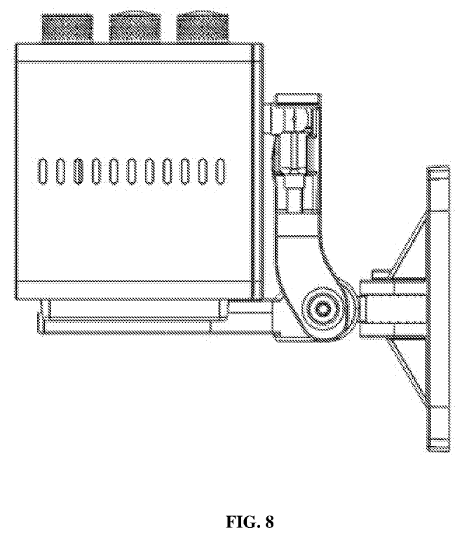

FIG. 8 is a right side view of a mounting bracket attached to a speaker. In this view, it can be seen that the magnet mechanism is coupled to the mating magnet mechanism on the device.

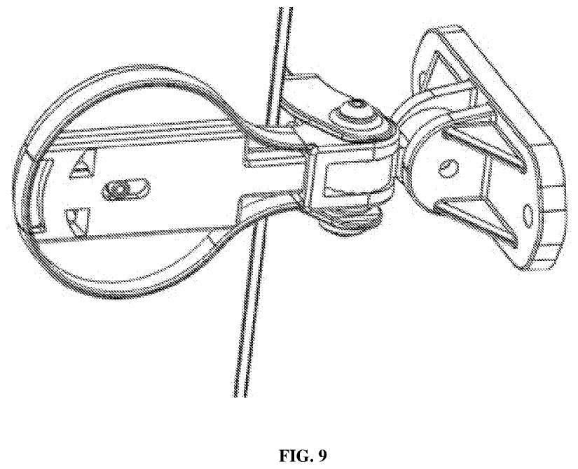

FIG. 9 is a bottom perspective view of the speaker mount assembly, showing the mechanical captivation mechanism for the device.

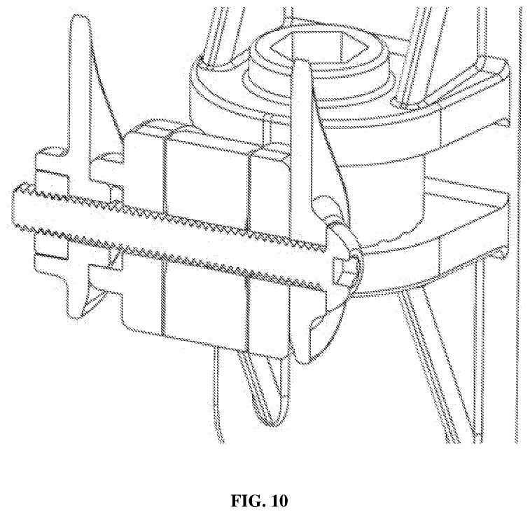

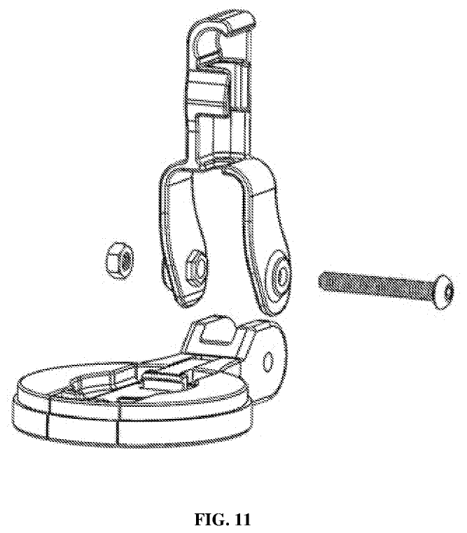

FIG. 10 is a section view of the joint connecting the speaker mount assembly, vertical cable mount assembly and wall bracket. In one embodiment, the bolt is fixed to the screw loosely to permit free rotation of the vertical cable mount. FIG. 11 is an exploded view of vertical cable mounting assembly and speaker mount assembly of a mounting bracket.

According to FIGS. 1 to 11, mounting bracket 100 holds a cable in a specific position, relative to another aligning element for the electronic device. This aligning element could be a mounting mechanism, aligning base, slot, groove, or some other element which ensures a reliable tolerance of location for the electronic device. Specifically, the vertical cable mount may also be constructed to allow the cable to move a small distance, particularly perpendicular to magnet 108. This reduction in tolerance of the cable captivation elements in vertical cable mount 102 can allow for more reliable alignment between the electrical connectors, as they will be further directed to the center of the alignment of the magnets.

When the electronic device is used together with the aligning element, the mounting bracket ensures that the charging cable is placed in close enough proximity to the charging port such that charging can commence. This charging port would have a self-finding element, such as a magnet, or funnel guides that helps to guide the charging cable to the port to make the connection.

This alignment element can be a second device or built into the cable mounting bracket. The mounting bracket may have a feature such that it has enough forgiveness such that it can flex or articulate to help the cable find the charging port, thus integrating more forgiveness into the system.

According to embodiments of this disclosure, a mounting bracket for quick connect between an electronic device and a magnetic charging cable is disclosed. The mounting bracket comprises a mount for mounting the bracket to a fixed feature of the environment and a vertical cable mount. The vertical cable mount further comprising a cable channel for a magnetic charging cable to run therethrough and a magnetic or ferrous element configured to provide connecting force to complete and maintain an electrical connection between the device and the cable.

According to the disclosure, the mounting bracket facilitates the mounting of a device and connection of a magnetic wired charging connection in a single action. The mounting bracket is formed from injection molded plastic. The mounting bracket is formed from stamped or cast metal.

According to the disclosure, the mounting bracket of claim 1 wherein the device is a speaker system and the device may be a powered speaker system with a battery.

According to further embodiments of the disclosure, a system of providing a simultaneous mechanical and electrical quick disconnect with an electronic device is disclosed. The system comprises a mechanical quick disconnect system that mechanically couples the device to a bracket, a vertical cable mount fixed to the mechanical bracket. The mechanical bracket further comprises a cable channel to hold a charging cable with a magnetically attractive termination and a means to allow the attractive force of a magnet to complete an electrical connection with at least one conductor.

According to the disclosure, the mounting bracket facilitates the mounting of a device and connection of a magnetic wired charging connection in a single action. According to the disclosure, the device is a speaker system and the mounting bracket is designed to be mounted to at least one of a mounting pole, bicycle frame, handlebars, or a mounting stand.

The functions described herein may be stored as one or more instructions on a processor readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer. It should be noted that a computer-readable medium may be tangible and non-transitory. As used herein, the term “code” may refer to software, instructions, code or data that is/are executable by a computing device or processor. A “module” can be considered as a processor executing computer-readable code.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

While the foregoing written description of the system enables one of ordinary skill to make and use what is considered presently to be the best mode thereof, those of ordinary skill will understand and appreciate the existence of variations, combinations, and equivalents of the specific embodiment, method, and examples herein. The system should therefore not be limited by the above-described embodiment, method, and examples, but by all embodiments and methods within the scope and spirit of the system. Thus, the present disclosure is not intended to be limited to the implementations shown herein but is to be accorded the widest scope consistent with the principles and novel features disclosed herein.

What is claimed:

1. A mounting bracket for quick connect between an electronic device and a magnetic charging cable, comprising:
a mount for mounting the bracket to a fixed feature of the environment;
a vertical cable mount, further comprising:
a cable channel for a magnetic charging cable to run therethrough; and
a magnetic or ferrous element configured to provide connecting force to complete and maintain an electrical connection between the device and the cable,
wherein the mounting bracket facilitates the mounting of a device and connection of a magnetic wired charging connection in a single action.

2. The mounting bracket of claim 1 wherein the bracket is formed from injection molded plastic

3. The mounting bracket of claim 1 wherein the bracket is formed from stamped or cast metal.

4. The mounting bracket of claim 1 wherein the device is a speaker system.

5. The mounting bracket of claim 4 wherein the device is a powered speaker system with a battery.

6. A system of providing a simultaneous mechanical and electrical quick disconnect with an electronic device, comprising:
a mechanical quick disconnect system that mechanically couples the device to a bracket,
a vertical cable mount fixed to the mechanical bracket, further comprising:
a cable channel to hold a charging cable with a magnetically attractive termination; and
a means to allow the attractive force of a magnet to complete an electrical connection with at least one conductor;
wherein the mounting bracket facilitates the mounting of a device and connection of a magnetic wired charging connection in a single action.

7. The system of claim 6 whereby the device is a speaker system.

8. The system of claim 6 whereby the mounting bracket is designed to be mounted to at least one of a mounting pole, bicycle frame, handlebars, or a mounting stand.
